(19) United States
(12) Patent Application Publication
(10) Pub. No.: US 2008/0252065 A1
(43) Pub. Date: Oct. 16, 2008

(54) Document of Value

(76) Inventors: Thomas Giering, Kirchseeon (DE); Wolfgang Rauscher, Munchen (DE)

Correspondence Address: BACON & THOMAS, PLLC, 625 SLATERS LANE, FOURTH FLOOR, ALEXANDRIA, VA, 22314-1176, US

(21) Appl. No.: 10/574,663

(22) PCT Filed: Oct. 5, 2004
(86) PCT No.: PCT/EP2004/011132

§ 371 Date: Jun. 26, 2008

(30) Foreign Application Priority Data
Oct. 8, 2003 (DE) 103 46 688.6

(51) Int. Cl. B42D 15/10; B05D 5/00

(52) U.S. Cl. 283/92; 427/288

(57) ABSTRACT

The invention relates to a document of value, in particular a bank note, with at least one pair of luminescent substances associated to each other having a first and a second luminescent substance, which emit in a joint emission region located outside the visible spectral region. According to the invention the emission spectra of the first and second luminescent substance overlap each other in at least a partial area of the said emission region in such a way, that the emission spectrum of the first luminescent substance is complemented by the emission spectrum of the second luminescent substance.

The invention relates to a document of value, which for increasing the forgery-proofness is provided with luminescent substances, as well as a method for producing it.

From the print WO 81/03508 is known a document of value having authenticity features in the form of luminescent substances that consist of a luminophore and absorbing substances. The absorption spectrum of the absorbing substances partially overlaps the excitation or emission spectrum of the luminophore and damps it in a characteristic and measurable way. Therefore, for an imitation of the authenticity feature, a determination of the respective luminophore is not sufficient, since its emission is changed in a characteristic fashion by the absorbing substances.

Starting out from the known solution, the invention is based on the problem to specify a different possibility, with which the emission of luminescent substances can be characteristically changed, so as to impart a high forgery-proofness to a document of value.

The problem is solved by the document of value having the features of the main claim. A method for producing such a document of value is subject matter of the independent claim. Advantageous developments of the invention are subject matter of the subclaims.

According to the invention the document of value has at least one pair of luminescent substances associated to each other with a first and a second luminescent substance, that emit in a joint emission region lying outside the visible spectral region. The emission spectra of the first and second luminescent substance overlap in at least a partial area of the said emission region in such a way that the emission spectrum of the first luminescent substance is characteristically complemented by the emission spectrum of the second luminescent substance, i.e. cannot be imitated in this form by single substances.

The invention is based on the finding, that the combination of two luminescent substances having emission spectra overlapping each other in a complementary fashion permits a high-quality and high-security change, since a spectral resolution of the luminescence emissions complementing each other cannot be successfully obtained unless with a high technical effort. When measuring the course of emission the sum signal of all luminescence emissions in the viewed spectral region is captured. It is very difficult to draw conclusions as to the chemical components of the luminescent substances on the basis of this sum signal, since the emission behavior of the luminescent substances does not only result from the substance properties but also from the respective quantitative proportions. Therefore, one cannot associate individual substances to a measured emission spectrum, unless at least some of the luminescence peaks can be differentiated and individual substances can be clearly associated. In the case of very strongly overlapping luminescence emissions, the recording and analyzing of the emission signal, therefore, requires a very high effort as to be able to associate the individual luminescent substances to the sum signal. Commercially available measuring systems do not operate with such a high effort, therefore, imitation attempts will fail because one cannot readily imitate the measured course of emission with commercially available luminescent substances. In case someone is successful in imitating the luminescence spectrum capturable with commercially available measuring systems, these attempts at forgery will be clearly recognized during the evaluation and analysis of the luminescence spectrum according to the invention, since it analyzes, in a way, the microstructure of the course of emission.

Since, as explained in more detail in the following, a great number of luminescent substances can be provided, which show an overlapping emission in suitable spectral regions, the solution according to the invention permits a multiplicity of possible protections and codings. Beside the high forgery-proofness, when applying or incorporating encoded information onto or in a document of value in this way, also a high information density is obtained.

In an advantageous embodiment the joint emission region of the two luminescent substances is in the range of about 750 nanometers to about 2500 nanometers, preferably about 800 nanometers to about 2200 nanometers, especially preferred about 1000 nanometers to about 1700 nanometers. If the relevant luminescence emission of a luminescent substance lies in a range of more than about 1000 nanometers, then it defies comparatively simple detection by commercially available silicon-based infrared detectors.

In a preferred embodiment the first and/or second luminescent substance is formed on the basis of a doped host lattice. These luminescent substances e.g. can be excited by directly radiating in the absorption bands of the luminescent ions and thereupon these emit. In preferred variants absorbing host lattices or so-called “sensitizers” can be employed, which absorb the excitation radiation and transfer it to the luminescent ion, which then emits itself with its characteristic wavelengths. It is understood, that the host lattice and/or the dopants can be different for the two luminescent substances, in order to obtain different excitation and/or emission regions.

In a preferred embodiment the host lattice absorbs in the visible spectral region and, optionally, additionally in the near infrared region up to about 1.1 microns. The excitation can be effected with high efficiency via light sources, such as halogen lamps, flash lamps, LEDs, laser or xenon arc lamps, so that only small amounts of the luminescent substance are required. With this it is possible, for example, to apply the luminescent substances onto the document of value with usual printing methods. Furthermore, the small substance amount makes it more difficult for potential forgers to detect the employed substance. If the host lattice absorbs in the near infrared up to about 1100 nanometers, easily detectable emission lines of the dopant ions can be suppressed, so that only the emission at larger wavelengths will remain, the detection of which requires a higher effort.

In an alternative preferred embodiment luminescent substances are used, which absorb even in the visible spectral region, preferably over the largest part of the visible spectral region, especially preferred up into the near infrared region. Here too emissions in these easier accessible spectral regions are suppressed.

In an advantageous variant of the document of value according to the invention, the first and/or second luminescent substance is a luminescent substance based on a host lattice doped with rare earth elements. Suitable dopants are in particular neodymium, erbium, holmium, thulium, ytterbium, praseodymium, dysprosium or a combination of these elements.

According to a different advantageous variant the first and/or second luminescent substance is a luminescent substance based on a host lattice doped with a chromophore, the chromophore being selected from the group scandium, titanium, vanadium, chromium, manganese, iron, cobalt, nickel, copper and zinc. The dopants and host lattices stated in WO 02/070279 are also suitable for being used as luminescent substances in documents of value according to the invention.

At least one of the host lattices can be doped with a plurality of chromophores. It is understood, that the two variants can be combined, i.e. that one of the luminescent substances is formed on the basis of a rare-earth-doped host lattice, the other luminescent substance on the basis of a host lattice with a chromophore.

The host lattice can have for example a perovskite structure or a garnet structure. At least one of the host lattices can also be formed by a mixed crystal. Further possible embodiments of the host lattices and dopants are listed in EP-B-0 052 624 or EP-B-0 053 124, the disclosures of which insofar are included in the present application.

According to a preferred embodiment of the document of value according to the invention, the first and second luminescent substance are formed on the basis of different host lattices, which have differently strong crystal fields and which each are doped with the same dopant. Because of the influence of the crystal field at the place of the dopant, the electronic levels of the dopants are displaced compared to the undisturbed state. Since the dimension of the displacement varies for the different levels, the result are, dependent on strength and symmetry of the crystal field, displacements in the energetic distances of the electronic levels and with that also in the position of the emission lines. If for the first and second luminescent substance the same dopant is chosen, by a suitable choice of host lattices having differently strong crystal fields, small displacements of the respective emission lines compared to the undisturbed emission can be adjusted in a controlled fashion.

The said partial area, in which the luminescence spectra of the first and second luminescent substance complementary overlap each other, preferably has a width of 200 nanometers or less, preferably 100 nanometers or less. In a preferred embodiment the partial area is in the range of about 850 nanometers to about 970 nanometers. In different, also advantageous embodiments the partial area is in the range of about 920 nanometers to about 1060 nanometers, or about 1040 nanometers to about 1140 nanometers, or about 1100 nanometers to about 1400 nanometers, preferably about 1100 nanometers to about 1250 nanometers, especially preferred about 1120 nanometers to about 1220 nanometers, or about 1300 nanometers to about 1500 nanometers, or about 1400 nanometers to about 1700 nanometers.

The first and the second luminescent substance each have in the said partial area preferably at least one emission line, the positions of which have a distance to each other of about 50 nanometers or less, preferably about 30 nanometers or less, especially preferred about 20 nanometers or less, very especially preferred about 10 nanometers or less. Such a small distance between the emission lines makes it difficult to detect, that two different luminescent substances are provided. In preferred embodiments the emission lines are narrow-band emissions lines and in particular have a half-value width of about 50 nanometers or less, preferably about 30 nanometers or less, especially preferred about 20 nanometers or less, very especially preferred about 10 nanometers or less.

According to an advantageous development of the invention the coding contains a further luminescent substance, which has at least one emission line outside the said partial area. The emission line preferably lies outside the visible spectral region, in particular in the infrared spectral region above 1100 nanometers. “Infrared spectral region” according to the invention means the wavelength range beginning at 750 nanometers and larger, preferably 800 nanometers and larger.

The document of value can also contain a plurality of pairs of luminescent substances associated to each other, which each can be formed as described. The luminescent substance pairs preferably are adjusted to each other such that the partial areas, in which the emission spectra of the two luminescent substances complementary overlap each other, are different for different pairs.

At least one of the luminescent substances can be printed onto the document of value. Likewise, a plurality of the luminescent substances, for example a pair of luminescent substances associated to each other, can be jointly printed onto the document of value in one printing ink. The printing inks used for this can be transparent or can contain additional coloring pigments, which must not impair the detection of the feature substances. In the case of luminescent substances, they have transparent areas preferably in the excitation and viewed emission region of the luminescent substances.

The document of value preferably comprises a substrate that is formed by a printed or unprinted cotton staple, a cotton/synthetic fiber paper, a paper containing cellulose, or a coated, printed or unprinted plastic foil. A laminated multilayer substrate is also suitable.

The documents of value according to the invention preferably are bank notes, share certificates, credit cards, ID cards, passes of any kind, visa, vouchers etc.

Likewise, one or a plurality of the luminescent substances can be incorporated in the volume of the document of value, in particular of the substrate of the document of value. The incorporation of the luminescent substances in the volume of a paper substrate can be effected, for example, according to a method such as described in the prints EP-A-0 659 935 and DE 10120 818. The disclosures of the mentioned prints insofar are included in the present application.

Apart from the possibility to be able to produce, “absolutely new emission spectra”, the invention also offers the possibility to produce codings via the number of the luminescent substances used, these codings are also difficult to imitate and thus difficult to forge. If, for example, two luminescent substances are used, which according to the invention overlap each other in a partial area of the spectrum, via the presence or absence of the individual luminescent substances at least three codings can be produced. But preferably a plurality of luminescent substances or a plurality of groups of luminescent substances complementing each other in a partial area of the spectrum, the luminescence emissions of which complement each other according to the invention in different partial areas of the spectrum, are used in order to form such codings.

A further variant for manufacturing codings consists in the pair or the pairs of luminescent substances associated to each other being provided in geometrically arranged areas on or in the document of value. One single area can also represent a coding. For example, the coding can consist in that a specific pair of luminescent substances of a number of possible pairs is present in this area of the document of value.

According to a preferred embodiment the coding represents an information about the document of value, the information being present in encrypted or unencrypted form. For example, the denomination of a bank note can be coded in an individual field of the note, when there is provided a predetermined pair of luminescent substances depending on the denomination.

By varying and combining the different dopants and host lattices a plurality of pairs of luminescent substances can be produced, their emission lines relevant for the coding complementary overlapping each other in different partial spectral regions. In this way very compact codings can be formed, which with their high information density take up only a small space on the document of value.

When manufacturing the described document of value at least one of the luminescent substances can be added to the document of value as early as during papermaking. Alternatively or additionally, at least one of the luminescent substances can be added to a printing ink and applied onto the document of value together with the printing ink. As printing methods can be used, for example, gravure printing methods, screen printing methods, relief printing methods, flexographic printing methods, ink-jet printing methods, digital printing methods, transfer printing methods or offset printing method. Likewise, at least one of the luminescent substances can be applied onto the document of value by a coating process.

According to a different variant, at least one of the luminescent substances is added to the document of value via respectively prepared mottled fibers during papermaking. A further possibility consists in that at least one of the luminescent substances is added via a respectively prepared security thread or security strip during papermaking. Likewise, a respectively prepared self-supporting transfer element, such as a patch or label, which is applied onto the document of value, in particular adhesively bonded, can serve for applying at least one of the luminescent substances.

The luminescent substances of a pair associated to each other preferably are added to the document of value with the help of the same method, in order to not facilitate an analysis on the basis of a spatial separation of the associated luminescent substances. Different pairs of luminescent substances, however, can be added with the help of different methods. For example, a first pair of luminescent substances can be incorporated in the paper substrate of a bank note during papermaking and a second pair of luminescent substances can be printed onto the bank note. A transfer element, such as a hologram patch, can be provided with a third pair of luminescent substances and adhesively bonded onto the bank note as a further security feature.

A further embodiment as well as advantages of the invention are explained in the following with reference to the Figures. For clarity's sake the figures do without a true-to-scale and true-to-proportion representation.

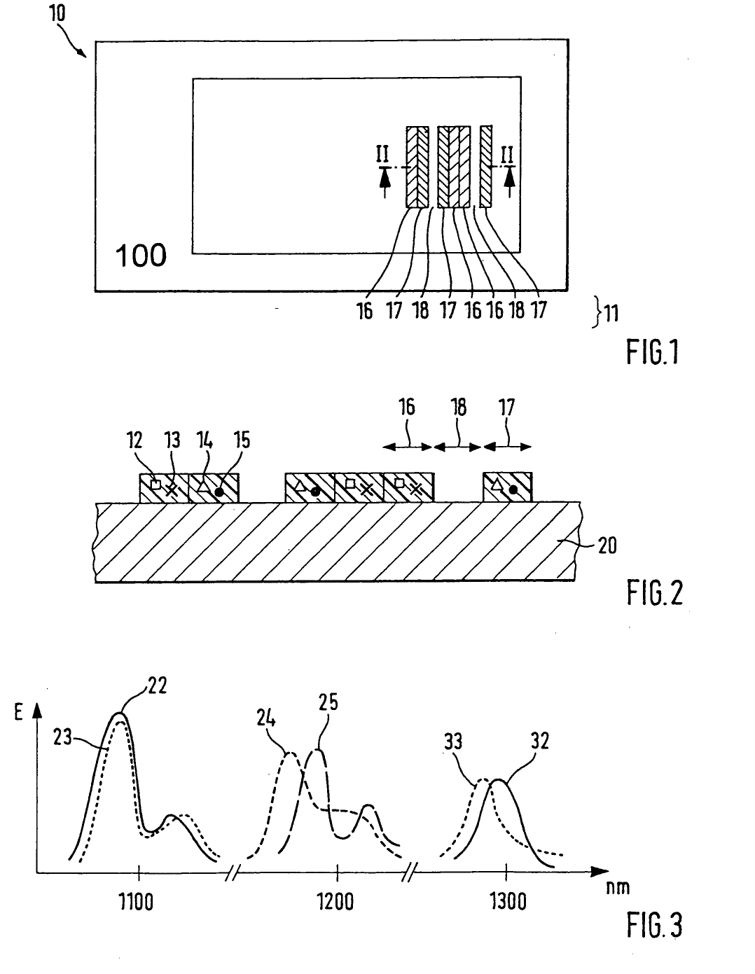

FIG. 1 shows a schematic representation of a bank note having a coding according to an embodiment of the invention,

FIG. 2 shows a section through the bank note of FIG. 1 along the line II-II, and

FIG. 3 shows schematic emission courses of different luminescent substances, as they can be used for coding the FIGS. 1 and 2.

In the following the invention is explained with reference to a bank note. FIGS. 1 and 2 show a schematic representation of a bank note 10, wherein a coding 11 is printed onto the paper substrate 20 of the bank note. FIG. 1 shows the bank note 10 in plan view and FIG. 2 a cross section along the line II-II of the FIG. 1.

As to be recognized best in FIG. 2, the coding 11 contains two pairs of luminescent substances 12, 13 or 14, 15 associated to each other. The luminescent substances 12-15 after being excited show emissions in the infrared spectral region between 1000 and 1500 nanometers, the emission spectra of two luminescent substances associated to each other complementary overlapping each other in a specific partial area of this spectral region, as described in detail in the following.

By arranging areas 16 having the first pair of luminescent substances 12, 13, areas 17 having the second pair of luminescent substances 14, 15, and areas 18 without luminescent substances along a predetermined geometric pattern, any information, for example the denomination and currency of the bank note 10 or a serial number can be stored in the coding 11.

With the shown coding can be represented, for example, a ternary code, wherein the state “0” is represented by an area not having luminescent substances, the state “1” by an area having the first pair of luminescent substances 12, 13, and the state “2” by an area having the second pair of luminescent substances 14, 15. Measuring the coding 11 shown in FIG. 1 with a suitable detector, therefore will detect the ternary coding “12021102”. With that a compact coding is provided, which combines a high forgery-proofness with a high information density and a small space requirement.

The luminescent substances 12 and 13 each are formed on the basis of a neodymium-doped host lattice and each have, as shown in the left part of the FIG. 3, an emission line in the range of about 1064 nanometers. The two luminescent substances 12, 13, however, are formed on the basis of different host lattices, which at the place of the neodymium ion produce differently strong crystal fields.

The interaction between the crystal field and the neodymium ions for the two luminescent substances results in, as above explained, slightly displaced emission lines 22 or 23 compared to the undisturbed value. In the embodiment the peak position in the course of luminescence 22 of the first luminescent substance 12 lies at a wavelength of 1065 nanometers and the peak position in the course of luminescence 23 of the second luminescent substance 13 at about 1090 nanometers.

As to be clearly recognized in FIG. 3, the two luminescence spectra 22, 23 overlap each other in the partial area of about 1000 nanometers to about 1150 nanometers in such a way, that the emission spectrum 22 of the first luminescent substance 12 is complemented by the emission spectrum 23 of the second luminescent substance 13. Due to the small distance between the two lines the presence of the two luminescent substances 12 and 13 cannot be recognized from the enveloping emission curve without knowing the substances used, so that the coding 11 has a high forgery-proofness. Since the spectrum is produced by different matrices, in which the luminescent ions are located in different crystal fields, there are no matrices that taken alone show the same emission spectrum.

The middle part of FIG. 3 shows the course of emission 24 and 25 of the luminescent substances 14 and 15 of the second pair of luminescent substances in the relevant partial area at wavelengths of 1150 to 1250 nanometers. In the embodiment each of the luminescent substances 14, 15 is formed on the basis of a host lattice doped with a chromophore, the chromophore being chosen from the group scandium, titanium, vanadium, chromium, manganese, iron, cobalt, nickel, copper and zinc. As with the first pair of luminescent substances, here too, from the envelope of the luminescence emissions of the two luminescent substances 14, 15 the kind of luminescent substances employed cannot be concluded without any further information.

A further example is shown in the right part of FIG. 3, the luminescence emission of the luminescent substances 12 and 13 mentioned before at a wavelength of about 1300 nanometers. There too the result are closely adjacent narrow emission lines 32 and 33, the joint luminescence emission of which can only be separated with high-resolution detectors.

The coding 11 beside the two pairs of luminescent substances 12, 13 or 14, 15 can also contain a further luminescent substance, which after excitation shows an emission at a wavelength above 1100 nanometers. Its emission wavelength being adjusted such that it does not fall in the overlapping areas of the first or second pair of luminescent substances. The presence or absence of the further luminescent substance in certain areas can also be used for coding and thus further increases the number of coding possibilities.

It is understood, that by the use of the above mentioned further luminescent substance or by the use of further pairs of luminescent substances of the above described kind even denser codings are possible.

Likewise, it is possible to provide all luminescent substances in one layer and to produce the coding via the presence or absence of individual luminescent substances or pairs of luminescent substances.

1. A document of value, comprising at least one pair of luminescent substances associated to each other and including a first and a second luminescent substance, said substances emitting in a joint emission region located outside the visible spectral region, wherein the emission spectra of the first and second luminescent substance in at least a partial area of the said emission region overlap in such a way that the emission spectrum of the first luminescent substance is characteristically complemented by the emission spectrum of the second luminescent substance.

2. The document of value according to claim 1, wherein the said emission region is in the range selected from the group consisting of about 750 nanometers to about 2500 nanometers; about 800 nanometers to about 2200 nanometers; and about 1000 nanometers to about 1700 nanometers.

3. The document of value according to claim 1, wherein the first and/or second luminescent substance is formed on the basis of a doped host lattice.

4. The document of value according to claim 1, wherein one or both of the first and second luminescent substance is or are formed on the basis of a host lattice doped with rare earth elements.

5. The document of value according to claim 4, wherein the host lattice is doped with one or more of elements selected from the group consisting of neodymium, erbium, holmium, thulium, ytterbium, praseodymium, and dysprosium.

6. The document of value according to claim 1, wherein one or both of the first and second luminescent substance is or are formed on the basis of a host lattice doped with a chromophore, the chromophore being selected from the group consisting of scandium, titanium, vanadium, chromium, manganese, iron, cobalt, nickel, copper and zinc.

7. The document of value according to claim 6, wherein at least one of the host lattices is doped with a plurality of chromophores.

8. The document of value according to claim 3, wherein at least one of the host lattices is formed by a mixed crystal.

9. The document of value according to claim 3, wherein the first and the second luminescent substance are formed on the basis of different host lattices, which have differently strong crystal fields and which each are doped with the same dopant.

10. The document of value according to claim 1, wherein the said partial area, in which the emission spectra of the first and second luminescent substance complementary overlap each other, has a width selected from the group consisting of 200 nanometers or less; and 100 nanometers or less.

11. The document of value according to claim 1, wherein the said partial area in which the emission spectra of the first and second luminescent substance overlap each other is in a range selected from the group consisting of about 850 nanometers to about 970 nanometers; about 920 nanometers to about 1060 nanometers; about 1040 nanometers to about 1140 nanometers; about 1100 nanometers to about 1400 nanometers; about 1100 nanometers to about 1250 nanometers; about 1120 to about 1220 nanometers; about 1300 nanometers to about 1500 nanometers; and about 1400 nanometers to about 1700 nanometers.

12. The document of value according to claim 1, wherein the first and the second luminescent substance in the said partial area each have at least one emission line, the positions of which have a distance selected from the group consisting of about 30 nanometers or less; about 20 nanometers or less; and about 10 nanometers or less.

13. The document of value according to claim 1, wherein the document contains a further luminescent substance which has at least one emission line located outside the said partial area.

14. The document of value according to claim 13, wherein the at least one emission line lies outside the visible spectral region.

15. The document of value according to claim 1, wherein the document has a plurality of said pairs of luminescent substances associated to each other.

16. The document of value according to claim 15, wherein the partial areas in which the emission spectra of the first and second luminescent substance of a pair complementary overlap each other are different for different pairs of luminescent substances associated to each other.

17. The document of value according to claim 1, wherein at least one of the luminescent substances is printed onto the document of value.

18. The document of value according to claim 17, wherein a plurality of luminescent substances are jointly printed onto the document of value in one printing ink.

19. The document of value according to claim 1, wherein the document of value comprises as a substrate a printed or unprinted cotton paper.

20. The document of value according to claim 1, wherein the document of value comprises as a substrate a printed or unprinted plastic foil.

21. The document of value according to claim 1, wherein at least one of the luminescent substances is incorporated in the volume of the document of value, in particular of a substrate of the document of value.

22. The document of value according to claim 1, wherein the pair of luminescent substances associated to each other are provided in geometrically arranged areas on or in the document of value.

23. The document of value according to claim 1, wherein the at least one pair of luminescent substances associated to each other forms a coding on or in the document of value.

24. The document of value according to claim 23, wherein the coding represents an information about the document of value, the information being provided in one of encrypted and unencrypted form.

25. A method for manufacturing a document of value, comprising: providing a document of value with at least one pair of luminescent substances associated to each other and which emit in a joint emission region located outside the visible spectral region, wherein the emission spectra of the first and second luminescent substance in at least a partial area of the said emission region overlap in such a way that the emission spectrum of the first luminescent substance is complemented by the emission spectrum of the second luminescent substance.

26. The method for manufacturing a document of value according to claim 25, wherein at least one of the luminescent substances is added to the document of value during papermaking.

27. The method for manufacturing a document of value according to claim 25, wherein at least one of the luminescent substances is added to a printing ink and is applied onto the document of value with the printing ink.

28. The method for manufacturing a document of value according to claim 25, wherein at least one of the luminescent substances is applied onto the document of value by a coating process.

29. The method for manufacturing a document of value according to claim 25, wherein at least one of the luminescent substances is added via respectively prepared mottled fibers during papermaking.

30. The method for manufacturing a document of value according to claim 25, wherein at least one of the luminescent substances is added via a respectively prepared security thread or security strip during papermaking.

31. The method for manufacturing a document of value according to claim 25, wherein at least one of the luminescent substances is applied onto the document of value via a respectively prepared self-supporting transfer element.

32. The document of value according to claim 14, wherein the emission line lies in the infrared spectral region above 1100 nanometers.
